(19) United States
(12) Patent Application Publication
(10) Pub. No.: US 2004/0051906 A1
(43) Pub. Date: Mar. 18, 2004

(54) Method for representing the halftone of an image and image treatment device and printing device for carrying out said method

(76) Inventors: Werner Engbrocks, Poing (DE); Ulrich Hermann, Freiburg (DE)

Correspondence Address: SCHIFF HARDIN, LLP, PATENT DEPARTMENT, 6600 SEARS TOWER, CHICAGO, IL, 60606-6473, US

(21) Appl. No.: 10/433,735

(22) PCT Filed: Oct. 18, 2001
(86) PCT No.: PCT/EP01/12087

(30) Foreign Application Priority Data
Dec. 8, 2000 (DE) 100-61-222.9

(51) Int. Cl. H04N 1/52

(52) U.S. Cl. 358/3.03; 358/535

(57) ABSTRACT

The invention relates to a method for representing the halftone of an image. The invention is based upon a combined scanning method with a dither matrix and an error diffusion method. According to the invention, when a halftone value of an image is determined, the colour value of image points which are not arranged next to the image point whose halftone value is being determined are corrected. Several colour values in particular are corrected. According to the inventive method, errors existing when determining a halftone value are distributed over a larger area, enabling predetermined point forms to be substantially maintained by the dither matrix.

The present invention is directed to a method for halftone presentation of an image as well as to an image processing device and to a printer device for the implementation of this method.

Methods for halftone presentation are particularly employed for printing black-and-white images in order to convert the individual grayscale values into digital halftone values for the bilevel printing. This is utilized in digital printers that usually reproduce only two colors: black (printing ink) or white (of the paper). This printing method is referred to as bilevel printing. No grayscale values (halftones) can be generated with bilevel printing. The reproduction of the grayscale is therefore simulated by a rastering of the image. When individual points are printed more or less regularly on white paper and these are observed from some distance, then the points dissolve to form a gray area because the human eye can no longer resolve these points. In order to simulate a darker grayscale value or, respectively, tonal value, the number of printed points is increased, whereby the proportion of the white area becomes smaller. In rastering, a plurality of small points on a surface give rise to a grayscale tone for the viewer.

Chapter 6 in the printer book, Technik und Technologien the OPS-Hochleistungs Drucker, Drucktechnologien, Océ Printing Systems GmbH, ISBN 3-00-001019-X, describes methods for generating halftone values.

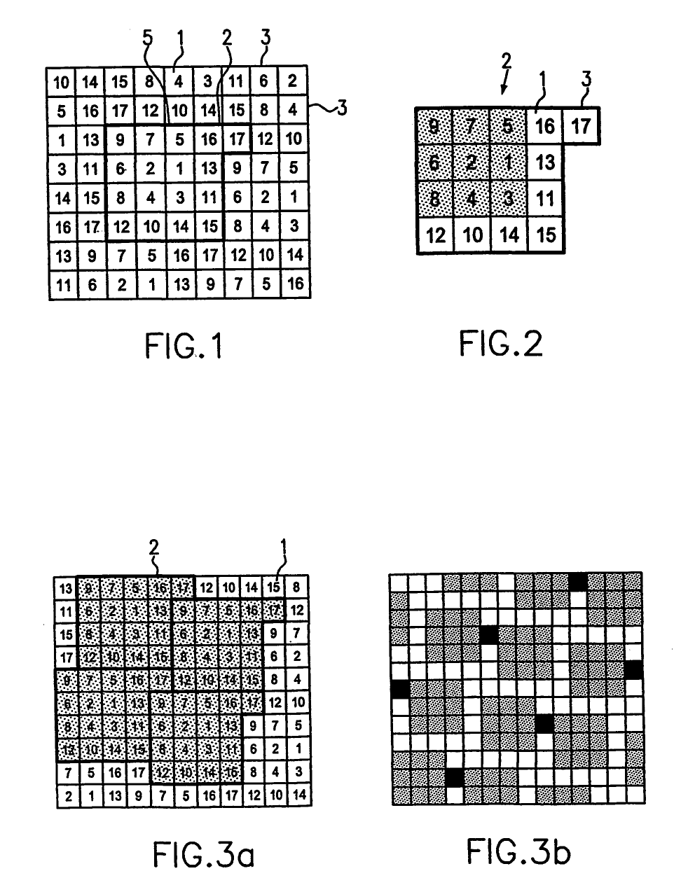

FIG. 1 shows a surface divided into small squares, whereby each square represents a picture element 1. The numbers entered into the individual picture elements correspond to a method for generating halftone values that is known by the name “clustered-dot ordered dither”. An image whose picture elements are described by color values can be converted into halftone values in that each color value of a picture element is compared to the corresponding threshold and the halftone value is set when the color value is greater than or equal to the threshold; when the color value is lower than the threshold, then the color value is not set.

The thresholds of the picture elements are combined to form raster cells 2 that repeat in order to thus be able to allocate thresholds to the complete area. The raster cells containing the thresholds represent a dither matrix 5, and the method for converting an image represented by color values into halftone values is also correspondingly referred to a dither method.

When an area is to be uniformly presented with 55.8% gray with the dither matrix shown in FIG. 1, then this corresponds to a grayscale value of 9.5, since the maximum threshold 17 is to be assigned to the maximum grayscale value (full saturation of black) and the value 0 is to be assigned to the minimum grayscale value (white). For a grayscales [sic] of 55.8%, thus, all halftone values of the picture elements whose thresholds is [sic] lower than 9.5 are set and the remaining halftone values are not set. FIG. 2 shows a cell wherein the picture elements whose halftone value are [sic] set are shown dark and the other picture elements are shown light. One can see that the picture elements whose halftone values are set lie next to one another within a raster cell.

Since only the picture elements whose halftone values are set are printed at the printer, this results therein that only a single, interconnected point is printed at the printer, the size thereof differing dependent on the gray level. This is advantageous for electrographic printing methods and many other printing methods that print circular points, since the size of the individual picture elements to be printed does not correspond exactly to the area allocated to a picture element, as a result whereof a pronounced variation in the deriving color saturation would occur given picture elements to be printed that are arranged distributed over the raster cell. When the picture elements of a raster cell that are to be printed are arranged neighboring one another, the individual, printed picture elements—which are usually larger that the areas exactly allocated to them—overlap one another and form a continuous, closed surface whose overall size, however, deviates only slightly from the size of the sum of the areas exactly allocated to the individual picture elements.

This bundling of the picture elements is also advantageous since the size of the individual picture elements is dependent on a few parameters such as, for example, whether the next, neighboring picture element is set, how much toner is offered, etc. The influence of this variation of the size of individual picture elements on the color saturation of the image is reduced by the bundling of a plurality of picture elements to form a large dot to be printed.

What is disadvantageous about this method is that only 18 color saturation levels are possible with a raster cell having 17 picture elements. When printing a brightness progression that changes gradually, these color levels become visible and generate edges in the printed image.

Fundamentally, there would be the possibility of enlarging the raster cells. The graduation of the individual, possible gray levels could be considerably refined as a result thereof. This, however, has the disadvantage that the points printed with a raster cell are relatively coarsely structured, so that the raster structure becomes visible and the human eye no longer perceives the individual points are gray tones.

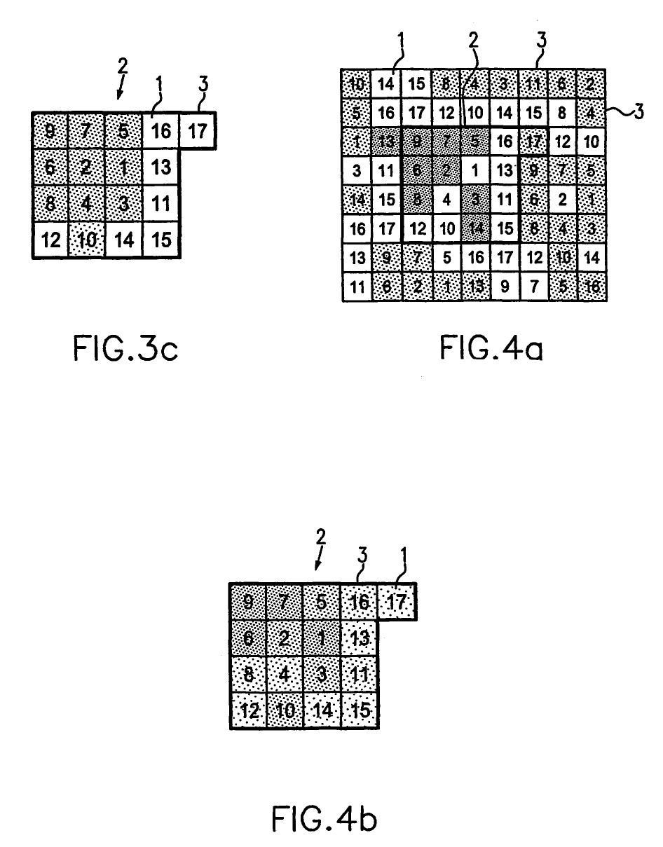

What is referred to as a super-cell method was developed in order to avoid these disadvantages. FIG. 3 shows the raster cell on which the super-cell method is based. In the super-cell method, a plurality of raster cells are combined to form a super-cell. Four raster cells are combined in the embodiment shown in FIG. 3. The individual raster cells correspond to the raster cell from FIG. 1.

When grayscale values are printed whose value are [sic] printed between the gray levels that can be printed with the above-described method, then a picture element that lies above the gray value is set in one or more of the raster cells of the super-cell. When, for example, a gray value of 55.8% is to be printed, then the halftone value of the picture element with the threshold 10 is set in every second raster cell. The pattern deriving therefrom is shown in FIG. 3b. FIG. 3c shows an individual raster cell with the thresholds allocated to the picture element, whereby the picture elements are occupied dark according to FIG. 3 corresponding to their frequency of occurrence in the pattern. the picture elements whose thresholds amount to between 1 and 9 are always set, for which reason they are shown maximally dark. The picture elements with the threshold 10 are only printed every second time, for example which reason it is [sic] shown half-dark., and the other picture elements are white since their halftone values are not set and they are therefore not printed.

The plurality of gray levels that can be presented with this method is considerably higher than with the above-described method. The individual points do not fray, for which reason this method is suitable for an electrographic printing method. As a result of the division of the super-cell into a plurality of discrete cells wherein an interconnected point is respectively generated, the structure is so fine that it can no longer be resolved by the human eye. However, the plurality of gray levels continues to be limited, so that structure that are visible due to corresponding edges arise in the image given a brightness progression that changes gradually.

The error diffusion method wherein [ . . . ] to raster an image with arbitrarily many grayscale values is also known. In this method, a constant threshold that amounts to approximately half the color saturation is employed. When determining whether the halftone value of a picture element is set, the color value, is compared to the threshold; the corresponding picture element is set when the color value is no lower than the threshold. However, a difference between the color value of the initial image and the color value corresponding to the halftone value is thereby calculated. Since the halftone values in bi-level printing correspond only to the full color saturation or not color saturation, the color values corresponding to the halftone values amount either to the amount corresponding to the full color saturation or to the amount corresponding to no color saturation. This difference represents a criterion for a deviation of the color saturation of the picture element of the initial image compared to the picture element described by the respective halftone values. The color values of the picture elements of the initial image that are arranged neighboring the picture element whose halftone value has been determined are corrected with this difference. The correction ensues by adding the difference or fractions of the difference to one or more color values. When a halftone value of a picture element is set, this results therein that the color values of the neighboring picture elements are reduced, as a result whereof the probability decreases that these [sic] the halftone values of these picture elements are set and, thus, these picture elements are printed. When the halftone value of a picture element is not set, then the probability increases that that halftone values of the neighboring picture elements are not set and these picture elements are not printed. A rastering of the image to be printed is generated as a result thereof.

Such an error diffusion method is known from U.S. Pat. No. 5,835,687, whereby the distribution of the error also ensues onto picture elements that do not neighbor the picture element from which the error has been derived.

EP 0 545 734 B1 discloses a further method for halftone presentation by means of error diffusion methods.

With the error diffusion method, an image can be presented with halftone values in arbitrary color saturation levels (grayscale values given employment of the color black). Images can thus be converted into images presented by halftone values with this compensation method. This method has therefore proven itself very well in applications wherein the individual picture elements can be presented with their exact size such as, for example, in presentation on a computer picture screen. In this error diffusion method, however, individual picture elements are often set. This is extremely disadvantageous for electrographic printing methods, since the size of such small point to be printed cannot be exactly supervised, and considerable deviations in color saturation can therefore occur at the printed image compared to the original. This error diffusion method can therefore not be employed in the above-described embodiment in printer devices that work according to the electrophotographic printing method.

U.S. Pat. No. 5,014,333 discloses an image processor that comprises a comparison device at which grayscale values are compared to the values of a dither matrix for generating a halftone presentation. An error value that is stored in a memory is simultaneously determined in this comparison. A correction value is calculated with a filter according to the error diffusion method on the basis of the error values stored in the memory. This correction value is weighted according to the average brightness of a region of the image to be printed wherein the picture element to be converted lies and is added to the grayscale value before this is supplied to the comparator. The comparator can employ different dither matrices that are in turn selected according to the brightness of the image region. This image processor is technologically very involved since it contains many different elements such as filters, comparators, converters and the like.

U.S. Pat. No. 5,031,050 discloses a method suitable for electrographically operating printer devices that combines the error diffusion method with the initially described rastering method. In this method, an error is calculated from all difference between the color values of the initial image and the printed color values of the picture elements of a raster cell. The individual differences are summed up to form a cell error. This cell error is divided by the number of picture elements of a raster cell and added to all thresholds of the next raster cell that are subsequently employed for setting the halftone values of the next picture elements.

In this method, thus, the error with respect to the color saturation within a raster cell is determined by conversion into halftone values, and this error is transferred onto a neighboring raster cell, whereby its thresholds are correspondingly corrected. This method allows arbitrary gray levels to be printed and is suited for electrographic printer devices since the dot form to be printed within a raster cell is retained. However, this method is involved in terms of the calculation of the individual raster cells, since the sum of all differences of a raster cell must first be determined, the difference amount is then to be calculated therefrom, all threshold of a further raster cell are to be corrected therewith before the actual dither method with which the halftone values are set can be implemented. Such a method is also involved to program since, in contrast to the initially cited method, it is not possible to always successively process all picture elements with the same routine; rather, the processing can only respectively ensue within a raster cell and the neighboring raster cell must be corrected before the halftone values of this one raster cell can be determined anew. A continuously in-step method wherein a single routine is successively applied to the individual picture elements is thus not possible.

The invention is based on the object for creating a method for the halftone presentation of an image with which arbitrary color saturations can be generated and that is suitable for electrographically working printer devices and is nonetheless simply structured and implementable with low calculating outlay.

This object is achieved by a method having the features of claim 1. Advantageous developments of the invention are recited in the subclaims.

The inventive method for halftone presentation is a combination of the aforementioned rastering method with dither matrix and the error diffusion method, and is characterized in that the difference value deriving when setting a halftone value of a specific picture element is employed for correcting a color value of at least one further picture element that is not arranged neighboring the specific picture element.

It is surprising that, due to the correction of color values of picture elements, whereby at least one of these picture elements is not a neighbor of the picture element from which the error has been derived, [ . . . ] leads thereto that the bundling of picture elements achieved by the employment of dither matrices is retained, as a result whereof the inventive method is especially well-suited for electrographic printing.

Since the difference value will distribute directly onto color values [. . . ] further picture elements in the inventive method, the inventive method can be significantly more simply implemented and realized in apparatus-oriented terms than is the case, for example, given the device according to U.S. Pat. No. 5,014,333.

The inventive method can be implemented in-step, i.e., when a halftone value of a specific picture element is set, the corresponding picture elements are corrected immediately thereafter with the assistance of the difference value that thereby derives. As a result thereof, it is not necessary to correct the dither matrix.

As a result of the correction of color values whose picture elements are at a distance from the picture element whose halftone value is set, the correction is displaced onto a region at a distance from the picture element to be set. This results therein when printing an image that is presented such with halftone values [. . . ] the individual picture elements to be printed are usually composed of a plurality of interconnected, individual picture elements that can be printed significantly more precisely with an electrographic printing method than points that are composed of only one or two or, respectively, three picture elements.

The invention thus creates an in-step method for halftone presentation of an image that is suited for utilization in electrographically working printer device [sic].

The invention shall be explained in greater detail below on the basis of an exemplary embodiment shown in the drawings. Shown in the drawings are:

FIG. 1 the division of an image into picture elements and raster cells with the corresponding thresholds;

FIG. 2 a raster cell with the thresholds in which the frequencies of occurrence of the halftone values that are set are illustrated with a specific gray level;

FIG. 3a the division of an image into what is referred to as a super-cell;

FIG. 3b the print pattern deriving upon employment of the super-cell from FIG. 3a for printing a prescribed gray level;

FIG. 3c a raster cell of the super-cell wherein the frequencies of occurrence with which the halftone values of the individual picture elements are set are represented by corresponding gray levels;

FIG. 4a a print pattern that derives when printing a specific gray level by means of a simple combination of the error diffusion method with a dither method;

FIG. 5 a print raster and the print points allocated to the individual cell elements;

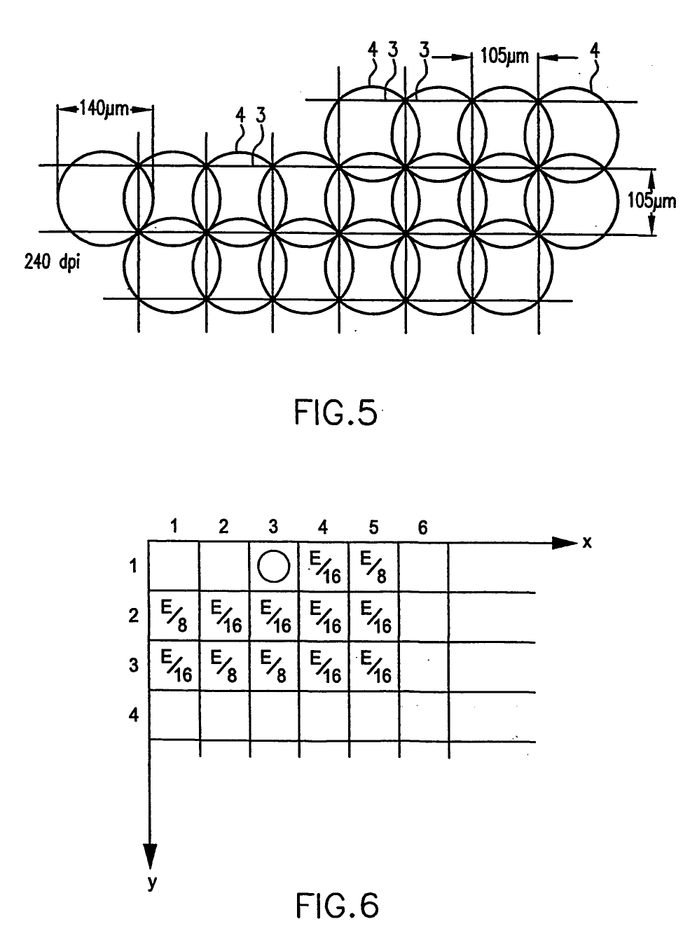

FIG. 6 a raster wherein the division [sic] of a difference value onto individual color values of further picture elements is shown;

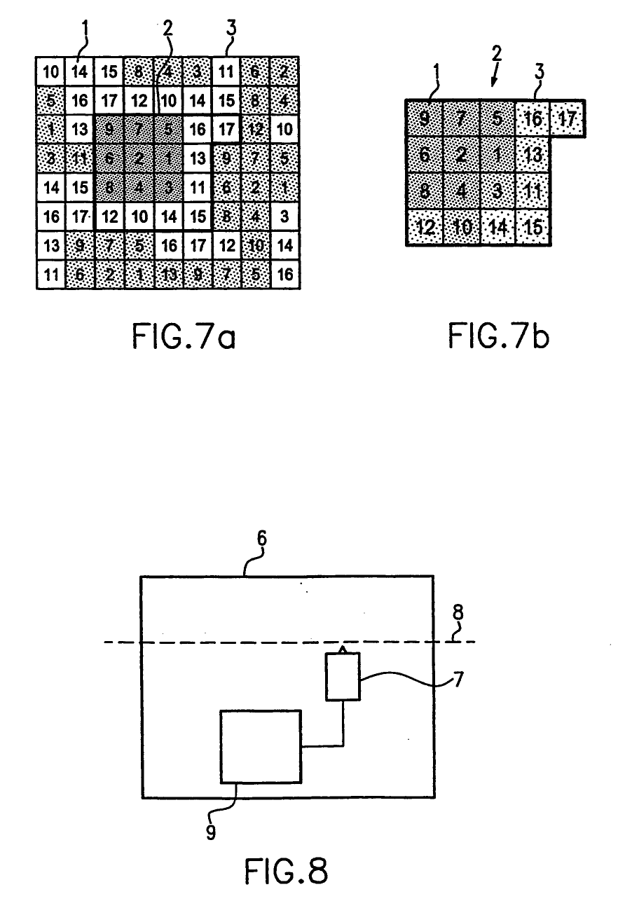

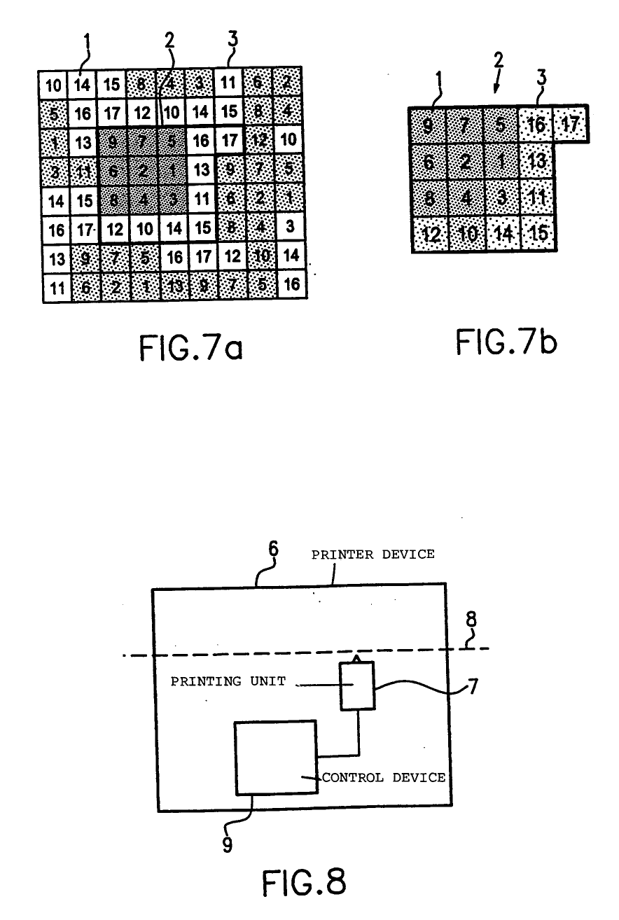

FIG. 7a a pattern that derives when printing with the method according to FIG. 6 when printing a prescribed gray level;

FIG. 7b a raster cell wherein the frequency of occurrence of the individual picture elements of the print pattern from FIG. 7a is presented by means of a corresponding gray level;

FIG. 8 a printer device for the implementation of the inventive method, shown schematically.

The inventive method is based both on the known dither method and the known error diffusion method. A halftone value is set when a color value describing a picture element is not below the threshold allocated to the picture element. When a picture element is set, then ink is printed at the location of the picture element. When the picture element is not set, then no ink is printed at the location of the picture element. The thresholds are prescribed by a dither matrix. The known design of the dither matrix generates a rastering in the printed image that the human eye cannot resolve and that presents itself as a specific color saturation to a human viewer. In a black-and-white image, the color saturation corresponds to the gray level.

As was already initially explained, there is the problem in the traditional error diffusion method that, when printing, the color saturation of the printed image often does not correspond to the original since printing points that are composed of a few (one, two or three) picture elements are formed in the error diffusion method. FIG. 5 shows the rastering for a printer having a resolution of 240 dpi. The individual cell elements 3 are squares having an edge length of 105 μm. The printing points 4 to be printed by a printer are circular and are set such that respectively one printing point 4 can completely cover a cell element 3. This means that the printing points 4 respectively project at the edges of the cell elements 3 and have a larger area than the cell elements 3. When, for example, the printing points are printed distributed like a checkerboard in the raster, then every printing point 4 extends into a neighboring, white element at all four sides of the cell element 3. Even though only merely [sic] half of all possible printing points are printed given such a distribution, the color saturation is significantly higher than 50%, since it is not only the cell elements 3 to be covered that are covered with ink but parts of the cell elements 3 that should remain free are also covered with ink.

When the printing points to be printed are bundled in neighboring cell elements 3, then the projecting regions of the printing points 4 usually extend into cell elements 3 that are also printed. As a result thereof, fewer surfaces that are not to be covered with ink per se are covered with ink. This leads thereto that the ratio between area covered with ink and area not covered with ink corresponds more exactly to the prescribed color saturation.

In electrographic printing methods, there is also the disadvantage that individual picture elements to be printed are often printed different in size. The influence of this variation of the size of the individual picture elements to be printed on the color saturation of the printed image can be reduced by the bundling of the picture elements.

In printing methods that essentially print circular dots and wherein halftone or, respectively, rastering methods are utilized, it is therefore expedient to bundle a plurality of printing points 4 adjacently adjoining and to avoid having many individual printing points 4 or printing points 4 that only adjoin one another in pairs printed.

Such printing methods are, in particular, electrographic printing methods such as, for example, electro-photostatic and electro-ionographic printing methods. However, this problem can also occur in offset printing processes and in other printing methods.

In the inventive method for the halftone presentation of an image, a difference value between a color value allocated to the picture element and the color value corresponding to the halftone value is calculated when setting a halftone value. When the color value is lower than the threshold, then the corresponding halftone value is not set and the difference between the color value of the picture element and the color value of the printed picture element (=white) is calculated as difference value. Given employment of a white print medium, the color value of the color “white” is equal to zero, for which reason the difference is the color value. When the color value is higher than the threshold, then the corresponding halftone value is set and the [ . . . ] the difference between the color value of the picture element and the color value of the printed picture element (=maximum color saturation) is calculated as difference value. This difference is negative. By adding the difference to one or more further color values, the probability that the picture elements corresponding to these color values will be printed is raised or lowered.

If only the [ . . . ] the color values of the neighboring piture [sic] elements [ . . . ] to the picture element whose halftone alue [sic] is identified were corrected, as known from the error diffusion method, then the print pattern shown in FIG. 4a would derive. The raster cell or, respectively, dither matrix shown in FIG. 1 was employed when printing this print pattern.

The print pattern shown in FIG. 4a is highly frayed and comprises many edges between printed and unprintedb [sic] areas. Such a print pattern is disadvantageous for electrographic printing.

Inventively, the difference value is divided into a plurality of difference sub-values, and color values of further picture elements whereof at least one picture element is not arranged neighboring the picture element whose halftone value is identified are corrected by adding one of the difference sub-values to the respective color value. Of course, color values of picture elements that are arranged neighboring the picture element whose halftone value is identified can also be corrected in the scope of the invention. What is critical for the invention, however, is that the correction of the color values also extends to color values of picture elements that do not neighbor the picture element whose halftone value is identified.

A specific exemplary embodiment of such a correction of the color values is shown in FIG. 6. FIG. 6 shows a raster of picture elements, whereby each cell element is a square. Coordinates X, Y are allocated are allocated to each cell element, whereby the cell element in the upper left corner has the coordinates (1, 1). The cell element or, respectively, the picture element (3, 1) is identified with a circle, which means that the halftone value of this picture element is determined. In bi-level printing, the halftone value is a digital value that, for example, can assume the values 1 or 0. When the halftone value is set to 1, then this means that the corresponding picture element is printed in full saturation when printing with ink. When the halftone value is set to 0, then the corresponding picture element is not printed with ink. Given employment of the raster cell with a dither matrix containing 17 elements that is shown in FIG. 1, the color values corresponding to the halftone values 1, 0 amount to 18 for full saturation and 0 for no saturation.

When determining the halftone value, a difference value E between the color value FA of the initial image allocated to the picture element and the color value allocated to the halftone value HW or, respectively, to the color value FD of the printed image is calculated. The color value describes the color saturation of the picture element. When the values of the halftone values are 1 for a set halftone value and 0 for a half tone value that is not set, then this relationship for the raster cell shown in FIG. 1 can be presented in the following equation:

E=FA−FD=FA−HW*18

The difference value E is divided into difference sub-values. In the present exemplary embodiment, the values E/8 and E/16 are employed as difference sub-values. They respectively amount to ⅛ or, respectively, 1/16 of the total difference value. The color values of the initial image of the picture elements (5, 1), (1, 2), (3, 2) and (3, 3) are respectively corrected by adding the difference sub-value E/8. The color values of the initial images of the picture elements (4, 1), (2, 2), (3, 2), (4, 2), (5, 2), (1, 3), (4, 3) and (5, 3) are respectively corrected by adding the difference sub-value E/16. Four color values are thus corrected with the difference sub-value E/8 and eight are corrected with the difference sub-value E/16. This means that the sum of all difference sub-values yields the difference value E. The difference value E is thus completely distributed onto a plurality of color values.

Beginning with the picture element (1, 1) of the upper left corner, the halftone values are determined in every line from left to right and line-by-line from top to bottom. When determining the halftone value for each and every picture element, the color values of the initial image of the picture elements following in the same line and respectively five color values in the two lines lying therebelow are corrected. In coordinate notation, this means that, given determination of the halftone value of the picture element (X, Y), the color values of the picture elements with the coordinates (X+1, Y), (X+2, Y), (X−2, Y+1), (X−1, Y+1), (X, Y+1), (X+1, Y+1), (X+2, Y+1), (−X2, Y+2), (−X1, Y+2), (X, Y+2), (X+2, Y+2) are corrected insofar as these picture elements are present. When, for example, the halftone values of picture elements at the left, right or bottom edge are to be determined, then some of the further picture elements whose color values are to be corrected would lie outside the boundary of the raster and are therefore not present.

The dither matrix shown in FIG. 1 is employed given the method for determining halftone values shown in FIG. 6. The pattern shown in FIG. 7a thereby derived given the presentation of a color saturation of 55.8%, which corresponds to a color value of 9.5. It has been surprisingly shown that none of the individual picture elements or picture elements standing free in pairs are printed but that all printed picture elements form an interconnected area. Compared to the pattern from FIG. 4a, there are significantly fewer boundary edges between printed and non-printed regions in FIG. 7a. The pattern in FIG. 7a is significantly less frayed than that in FIG. 4a. This leads to a significantly more precise setting of the color saturation prescribed by the original image or of the gray level when this is a black-and-white image.

FIG. 7b shows the frequency of occurrence of the picture elements printed with the inventive method given a color saturation of 55.8% on the basis of the brightness of the individual cell elements 3 of the raster cell 2. The dark cell elements 3 with the thresholds 9, 7, 5, 6, 2, 1, 8, 4 have been printed most often. They are arranged adjoining one another. The cell elements 3 having the thresholds three and ten have been printed with the second highest frequency of occurrence. The other cell elements were printed less often. When the image from FIG. 7b is compared to the image from FIG. 4b, then one can see that the frequently printed cell elements are arranged bundled. This shows the effect of the inventive method, which generates very compact points in the printed image.

This is inventively achieved by an in-step correction that is achieved given every determination of a halftone value of a cell element.

The method is based on the raster cell shown in FIG. 1. The greatest variety of types of raster cells are in standard use in printing technology. Given some other raster cell, of course, it can be expedient to distribute the difference value onto the color values of further picture elements in some other way. Regardless of the fashioning of the raster cell, the crux of the invention is comprised in correcting not only color values of neighboring picture elements of the picture element from which the halftone value was determined but in also correcting color values at a greater distance. What this avoids is that the difference sub-values of successive correction steps add up so quickly that the printed points fray greatly. With the inventive method, thus, the error correction is relocated to neighboring rastr [sic] cells, as a result whereof the fraying of the points to be printed is avoided.

It is therefore advantageous when the difference value is divided into a plurality of difference sub-values that are preferably distributed onto 5 or more, particularly 12 through 21, color values.

As a result thereof, the shape of the points to be printed can be essentially retained as prescribed by the selection of the raster cell.

Since the individual printing points given bundling of the picture elements extend into region of picture elements not to be printed, there is an imprecision, albeit slight, with respect to the color saturation. This can be compensated when setting the halftone values in that whether the halftone values of one or two immediately neighboring picture elements are already set is taken into consideration. When, for example, the halftone values of one or two neighboring picture elements have already been set, then this means that these two neighboring picture elements are printed. When the picture element whose error E is to be identified is not printed, then its edge region is nonetheless printed somewhat by the neighboring, overlapping picture elements. Even though the halftone value is 0, this results therein that a color value differing from 0 is to be allocated to this picture element. Given employment of the raster cell shown in FIG. 1, it has been shown that the value 2 is to be set in the calculation of the error E for the color value FD of the printed picture element given a set halftone value of an immediately neighboring picture element, and the value 3 is to be set given two set halftone values of neighboring picture elements.

When the neighboring picture elements are not printed and when the picture element whose halftone value is to be determined is to be printed, then this printed point extends into the regions of the neighboring picture element, as a result whereof the color saturation is higher than in printed neighboring picture elements. It has been shown given employment of the raster cell shown in FIG. 1, that the value 20 should be set given a non-set halftone value of an immediately neighboring picture element in the calculation of the error E for the color value FD of the printed picture element, and the value 22 should be set given two non-set halftone values of neighboring picture elements. The color values FD of the printed picture elements can thus be corrected according to the following table:

| Number of printed | | | |
|---|---|---|---|
| neighboring picture | | | |
| elements | 0 | 1 | 2 |
| FD for HW = 0 | 0 | 2 | 3 |
| FD for HW = 1 | 22 | 20 | 20 |

FIG. 8 shows a printer device 6 for the implementation of the inventive method. This printer device 6 comprises an electrographically working printing unit 4, particularly an electrophotographically or electroionographically working printing unit, with which approximately circular printing points are printed in a raster on a paper web 8. The printer device 6 is provided with a control device 9 that converts the color values of an image into halftone values and that drives the printing unit 7 to print the picture elements to be printed according to the halftone values. When a halftone value has the value 1, then the corresponding picture element is printed; when a halftone value has the value 0, then the corresponding picture element is not printed. The conversion of the image described with color values into halftone values ensues according to the above-recited exemplary embodiment.

The invention can be utilized in electronic devices such as image processing circuit arrangements, computers and printer devices. It can thereby be particularly implemented with hardware modules and/or software components. Computer program products such as, for example, diskettes, CD-ROMs or other storage elements on which computer programs that implement the inventive method given execution on a computer are stored are also covered by the inventive teaching.

The invention has been described above on the basis of an exemplary embodiment for bi-level printing. Of course, it is also possible to determine the halftone values of a multi-level print in the context of the invention. The dither matrices suitable for multi-level printing must thereby merely be employed, and the color saturation values corresponding to the different stages of the multi-level printing must be allocated to the color values (FD) of the printed picture element.

The invention can also be employed for a multi-color print, whereby the colors are separately converted into their halftone values.

The invention can be summarized in brief in the following way: The invention is directed to a method for the halftone presentation of an image and is based on a combination of a raster method with dither matrix and an error diffusion method. Inventively, color values of picture elements that are not arranged neighboring the picture element whose halftone value is determined are corrected in the determination of a halftone value of a picture element. In particular, a plurality of color values are corrected.

In the inventive method, the error existing in the determination of a halftone value is distributed onto a larger region, as a result whereof the point shape prescribed by the dither matrix is essentially retained.

List of Reference Characters

| | |
|---|---|
| 1 | picture element |
| 2 | raster cell |
| 3 | cell element |
| 4 | printing point |
| 5 | dither matrix |
| 6 | printer device |
| 7 | printing unit |
| 8 | paper web |
| 9 | control device |

1. Method for the halftone presentation of an image, whereby picture elements (1) of an initial image are presented by a respective color value, whereby the color value describes the color saturation of the respective picture element (1), and a dither matrix (5) is employed that contains thresholds, whereby a threshold of the dither matrix (5) is allocated to each picture element (1), and a halftone value is set when the color value of the respective picture element (1) is higher than or equal to the threshold, and the halftone value is not set when the color value is lower than the threshold, whereby the following steps are executed when setting a halftone value of a specific picture element (1):
calculating a difference value (E) between the color value (FA) of the picture element of the initial image and the color value (FD) of this picture element (1) in the image to be printed;
dividing the difference value (E) into a plurality of difference sub-values (E/8, E/16);
correcting color values of further picture elements (1) of the original image by adding a respective difference sub-value (E/8, E/16) to one of the color values to be corrected, whereby at least one of these further picture elements does not neighbor a specific picture element (1) whose halftone value is determined; and
employing the corrected color values in the determination of the respective halftone value of the further picture elements (1).

2. Method according to claim 1, characterized in that at least six color values of the initial image are corrected in the determination of a halftone value by adding a difference sub-value.

3. Method according to claim 1 or 2, characterized in that the picture elements (1) of an image are arranged in rows and columns, whereby the halftone values of the picture elements (1) in the rows are successively set from left to right and the rows are processed from top to bottom, whereby, when determining the halftone value of a specific picture element, the coordinates X, Y are allocated to this picture element, whereby X describes the column of the picture element (1) and Y describes the row of the picture element (1), and X+1 describes the column to the right of and Y+1 describes the row below the specific picture element (1), and color values (FA) of picture elements (1) of the columns X+1, X+2 and/or the rows Y+1, Y+2) are corrected, insofar as these picture elements are present.

4. Method according to claim 3, characterized in that color values (FA) of the picture element (1) of the column X+3 and/or Y+3 are corrected, insofar as these are present.

5. Method according to claim 3 or 4, characterized in that color values (FA) of the picture elements (1) with the coordinates (X+1, Y), (X+2, Y), (X−2, Y+1), (X−1, Y+1), (X, Y+1), (X+1, Y+1), (X+2, Y+1), (X−2, Y+2), (X−1, Y+2),(X, Y+2), (X+1, Y+2), (X+2, Y+2) are corrected insofar as these picture elements are present.

6. Method according to claim 5, characterized in that a respective differential sub-value that amounts to ⅛ of the difference value is added to the color values (FA) of the picture elements (X, Y+2), (X−1, Y+2), (X−2, Y+1) and (X+2, Y), and a respective difference sub-value that amounts to 1/16 of the difference value to the other thresholds to be corrected.

7. Method according to one of the claims 1 through 6, characterized in that the following dither matrix is employed:

| | | | | |
|---|---|---|---|---|
| 9 | 7 | 5 | 16 | 17 |
| 6 | 2 | 1 | 13 | |
| 8 | 4 | 3 | 11 | |
| 12 | 10 | 14 | 15. | |

8. Method according to one of the claims 1 through 7, characterized in that the color values describe the color saturation of a single color.

9. Method according to claim 8, characterized in that the color values describe the color saturation of the color black.

10. Method according to one of thwe [sic] claims 1 through 9, characterized in that, when calculating the difference value (E), the color values (FD of the picture element to be printed are corrected dependent on whether immediately neighboring picture elements of the picture element whose halftone value is determined are printed.

11. Method according to one of the claims 1 through 10, characterized in that the halftone values are employed for driving a printer device, whereby a color point is printed on a substrate at every picture element to which a set halftone value is allocated and no color point is printed at each picture element to which as non-set halftone value is allocated.

12. Method according to claim 11, characterized in that an electrographic printing method is employed.

13. Image processing device for the implementation of the method one of the claims 1 through 12.

14. Printer device for the implementation of the method according to one of the claims 1 through 12, comprising
an electrophotographically working printing unit (7),
a control device (9) that converts the color values of an image into halftone values and that drives the printing unit (7) to print the picture elements to be printed corresponding to the halftone values, whereby the control device (9) is fashioned for the implementations of the method according to one of the claims 1 through 10.
